(19) United States
(12) Patent Application Publication
(10) Pub. No.: US 2006/0050298 A1
(43) Pub. Date: Mar. 9, 2006

(54) Image forming system and method using removable storage medium

(76) Inventor: Tae-jung Yun, Seoul (KR)

Correspondence Address: Stanzione & Kim, LLP, 1st Fl., 1740 N St., NW, Washington, DC, 20036, US

(21) Appl. No.: 11/199,083

(22) Filed: Aug. 9, 2005

(30) Foreign Application Priority Data
Sep. 4, 2004 (KR) 2004-70617

(51) Int. Cl. G06F 3/12

(52) U.S. Cl. 358/1.15

(57) ABSTRACT

An image forming system in which a plurality of print job files are stored in a removable storage medium, and a print job selected by a user from the stored print jobs is performed according to print settings of the print job files, and an image forming method thereof. The image forming system using the removable storage medium includes a storage medium to store image data to be printed, a plurality of print job files corresponding to the image data, and an index file having information on the plurality of print job files, an image capturing apparatus to which the storage medium can be attached to generate the image data, print job files, and index file, and to store the image data, print job file, and index file in the storage medium, and an image forming apparatus to which the storage medium can be attached to receive a selection of one of a plurality of print jobs corresponding to the print job files stored in the storage medium, and to print the image data stored in the storage medium according to a print job file of the selected print job. When the image data stored in the removable storage medium is printed, the plurality of print job files and the index file having information on the print jobs are generated and stored in the storage medium to perform the print job selected by the user using the index file, thereby reducing time required for the print job and inconvenience caused by the print job.

### CROSS-REFERENCE TO RELATED APPLICATIONS

This application claims under 35 U.S.C. §119 the priority of Korean Patent Application No. 10-2004-70617, filed on Sep. 4, 2004, in the Korean Intellectual Property Office, the disclosure of which is incorporated herein in its entirety by reference.

### BACKGROUND OF THE INVENTION

1. Field of the Invention

The present general inventive concept relates to an image forming system and method, and more particularly, to an image forming system in which a plurality of print job files are stored in a removable storage medium of an image capturing apparatus and an image forming apparatus, and a print job selected by a user corresponding to one of the stored print job files is performed according to print settings of the corresponding print job file, and an image forming method thereof.

2. Description of the Related Art

When printing image data is generated using an image capturing apparatus, such as a digital camera, the generated printing image data is printed using a personal printer or is transferred to a photofinishing service provider to be printed. The photofinishing service provider is less expensive and produces better preserved images than the personal printer, since the personal printer is much complicated to use and likely to obtain a wrong image. Therefore, the photofinishing service provider is generally used to print the images.

A removable storage medium of the image capturing apparatus and a printer makes it possible to easily print an image using the personal printer by reducing complexity of printing.

A digital print order format (DPOF) is a standard for directing printing from a digital camera including a removable storage medium storing a print job file having information on print job settings, such as number of prints, print format, etc., and image data to be printed. In the DPOF, the printer prints an image according to the printing job settings of the print job file stored in the removable storage medium.

FIG. 1 is a block diagram of a conventional image forming system using a general removable storage medium. The image forming system comprises a digital camera 100, a storage medium 110, and a printer 120.

The digital camera 100 generates image data according to a user operation and stores the generated image data desired by the user and a print job file having information on settings to be applied to a print job in a pre-specified folder of the storage medium 110. When a plurality of images are to be printed, a plurality of print settings for the respective images are generated and stored in a single print job file stored in the storage medium 110.

After the image data and the print job file are stored in the storage medium 110, the user separates the storage medium 110 from the digital camera 100 and attaches it to the printer 120.

The printer 120 searches the print job file in the storage medium 110 and prints the image data according to the information of the print job file.

As described above, the conventional image forming system generates the single print job file for a plurality of print jobs and stores it in a specific folder of the storage medium, which limits the print job capable of being stored in the storage medium and causes inconveniences when the print job is set and searched. Further, when the print jobs are performed in the printer to which the storage medium is attached, every print job stored in the storage medium must be completed.

### SUMMARY OF THE INVENTION

The present general inventive concept provides an image forming system in which, when printing an image using a removable storage medium, a plurality of print job files and an index file having information on print jobs to be performed are stored in a removable storage medium to perform a print job selected by a user among the stored print jobs using an index file according to settings of the print job files, and an image forming method thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an image forming system using a removable storage medium and an image forming apparatus, the image forming system comprising a storage medium to store image data to be printed, a plurality of print job files corresponding to the image data, and an index file having information on the plurality of print job files, an image capturing apparatus to which the storage medium can be attached to generate the image data, print job files, and index file, and to store the image data, print job files, and index file in the storage medium, and an image forming apparatus to which the storage medium can be attached to receive a selection of one of a plurality of print jobs corresponding to the print job files stored in the storage medium, and to print the image data stored in the storage medium according to at least one of the print job files corresponding to the selected print job.

The image capturing apparatus may store the print job files in a plurality of folders of the storage medium, and the print job files are in an XHTML (extend HTML) format.

The image forming apparatus may comprise a display unit to display the print jobs stored in the storage medium using the index file, a user input unit to receive the selection of the print job among the displayed print job files; and an image print unit to print the image data stored in the storage medium corresponding to the print job file of the selected print job.

The foregoing and/or other aspects and advantages of the present general inventive concept may also be achieved by providing an image forming method of performing a printing operation using a removable storage medium and an image forming apparatus, the image forming method comprising generating image data to be printed, a plurality of print job files corresponding to the image data, and an index file having information on the plurality of print job files, storing the image data, the print job files and the index file in the storage medium, receiving a selection of one of a plurality of print jobs using print job information of the index file, and printing the image data stored in the storage medium according to the print job file of the selected print job.

The storing of the print job files may comprise storing the print job files in a plurality of folders of the storage medium, and storing the print job files in an XHTML format.

The receiving of the input job may comprise displaying the print jobs stored in the storage medium using the index file, and receiving the selection of one of the displayed print jobs.

The printing of the image data may comprise searching for the print job file of the selected print job in the storage medium, searching for the image data corresponding to the selected print job in the storage medium, and printing the searched image data according to print settings stored in the print job file.

The foregoing and/or other aspects and advantages of the present general inventive concept may also be achieved by providing a computer readable medium embodied thereon a computer program to perform an image forming method of generating image data to be printed, a plurality of print job files corresponding to the image data, and an index file having information on the plurality of print job files, storing the image data, the print job files and the index file in the storage medium, receiving a selection of one of a plurality of print jobs using print job information of the index file, and printing the image data stored in the storage medium according to the print job file of the selected print job.

The foregoing and/or other aspects and advantages of the present general inventive concept may also be achieved by providing an image capturing apparatus to generate image data and store the image data in a removable storage medium, the image capturing apparatus comprising a data generator to generate the image data, a file generator to generate a plurality of print job files corresponding to the image data for printing, and an index file having information on the print job files, and a controller to store the image data, print job files, and index file in the storage medium.

The controller may store the print job files in a plurality of folders of the storage medium, and the print job files may be in an XHTML format.

The foregoing and/or other aspects and advantages of the present general inventive concept may also be achieved by providing an image forming apparatus to print image data stored in a removable storage medium, the image forming apparatus comprising a user input unit to receive an selection of one of a plurality of print jobs corresponding to a plurality of print job files stored in the storage medium, a search unit to search for the print job file of the input print job and image data corresponding to the print job file in the storage medium, and an image printing unit to print the image data corresponding to the selected print job.

The apparatus may comprise a display unit to display the print jobs stored in the storage medium using the index file having information on the print job files stored in the storage medium.

The search unit may search for the print job file of the input print job in the storage medium using the index file, and searches for the image data corresponding to the selected print job in the storage medium.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional image forming system using a general removable storage medium;

FIG. 2 is a block diagram illustrating configuration of an image forming system using a removable storage medium according to an embodiment of the present general inventive concept;

FIG. 3 is a block diagram illustrating an image capturing apparatus according to an embodiment of the present genera inventive concept;

FIG. 4 is a view illustrating a directory tree produced when storing a generated index file in a storage medium of FIG. 2;

FIG. 5 is a view illustrating a directory tree produced when storing generated print job files in a storage medium of FIGS. 2 and 3;

FIG. 6 is a block diagram illustrating an image forming apparatus according to an embodiment of the present general inventive concept;

FIG. 7 is a diagram illustrating a method of searching for a print job file and image data in a storage medium of FIGS. 2 and 6;

FIG. 8 is a flow chart illustrating an image forming method using a removable storage medium according to an embodiment of the present general inventive concept;

FIG. 9 is a flow chart illustrating a method of storing image data, print job files, and an index file in a storage medium in the image capturing apparatus of FIG. 3; and

FIG. 10 is a flow chart illustrating a method of printing image data stored in a storage medium of the image forming apparatus of FIG. 6.

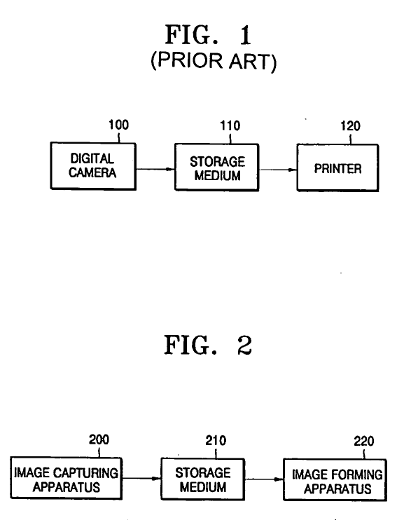

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

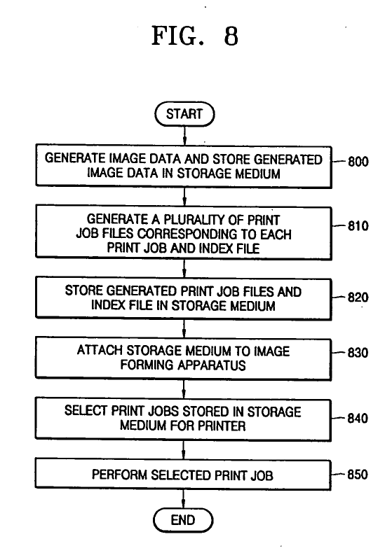

FIG. 2 is a block diagram of an image forming system using a removable storage medium according to an embodiment of the present general inventive concept. The image forming system comprises an image capturing apparatus 200, a storage medium 210, and an image forming apparatus 220. An operation of the image forming system will now be described with reference to a flow chart illustrating an image forming method using a removable storage medium shown in FIG. 8.

The image capturing apparatus 200 generates image data to be printed according to a user operation, and stores the image data in a predetermined folder of the storage medium 210 in operation 800. The folder indicates a location of the storage medium 210, and the location of the storage medium 210 can be defined by a user. The image capturing apparatus 200 may be one of a digital camera, a PDA (Personal Digital Assistant), a wireless terminal, and the like. After the image capturing apparatus 200 generates the image data, when the user prints one or more images included in the generated image data, the image capturing apparatus 200 generates print job files having print setting values that correspond to the respective images that are used to perform a plurality of print jobs according to a user input, and an index file storing information on the plurality of print jobs in operation 810.

The print job files contain information on the image data in the folder where the image data for the respective print jobs are stored in the storage medium 210, and print setting values regarding printing functions, such as number of prints, rotation print of image, frame printing, etc. The print job files are in an XHTML (extend HTML) format. The index file has a file extension defined by the image capturing apparatus 200 and the image forming apparatus 220, and includes information on the plurality of print jobs stored in the storage medium 210 such as names of the print job files, stored folders, etc.

The image capturing apparatus 200 stores the generated print job files and index file in the storage medium 210 in operation 820. The image capturing apparatus 200 may store the files in an optional folder, not just the predetermined folder, of the storage medium 210, and store the print job files in a plurality of optional folders, respectively, as desired by a user.

When performing the print jobs stored in the storage medium 210 using the image forming apparatus 220, the user separates the storage medium 210 from the image capturing apparatus 200, and attaches the separated storage medium 210 to the image forming apparatus 220 in operation 830. The storage medium 210 can be any storage medium that can be detached from and attached to the image capturing apparatus 200 and the image forming apparatus 220, or may be one of a flash memory card, smart media, a PCMCIA card, a floppy disk, a magnet-optic disk, etc.

The image forming apparatus 220 provides the user with information on the print jobs stored in the attached storage medium 210 using the index file, and the user selects an image to be printed by selecting one of the print jobs stored in the storage medium 210 using the provided information on the print jobs in operation 840. The user may select one of the plurality of the print jobs stored in the storage medium 210, so that the image forming apparatus 220 prints one of a plurality of images.

The image forming apparatus 220 searches for one of the selected print jobs in the storage medium 210 using a location of the selected print job file indicated in the index file, searches for the corresponding image data in the storage medium 210 using a location of the image data indicated in the searched print job file, and prints the searched image data according to the print settings of the print job file in operation 850.

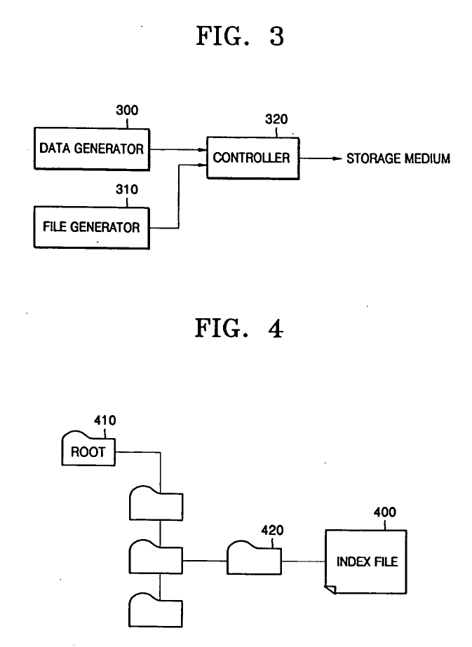

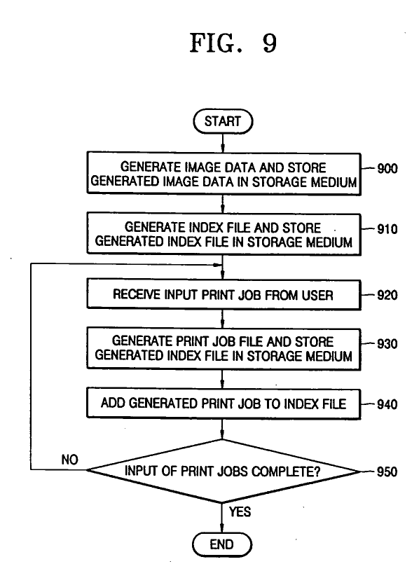

FIG. 3 is a block diagram of an image capturing apparatus according to an embodiment of the present general inventive concept. The image capturing apparatus comprises a data generator 300, a file generator 310, and a controller 320. An operation of the image capturing apparatus will now be described with reference to a flow chart illustrating a method of storing image data, print job files, and an index file in a storage medium shown in FIG. 9.

Referring to FIGS. 2, 3, and 9, the data generator 300 generates the image data of an image to be printed according to a user operation, and the controller 320 stores the generated image data in a predetermined folder of the storage medium 210 in operation 900.

When the user prints the generated image data, the file generator 310 generates the index file having information on print jobs desired by the user, and the controller 320 stores the generated index file in a folder designated by the user or an optional folder among folders of the storage medium 210 in operation 910.

The file generator 310 receives input image data to be printed and input information regarding print functions, such as number of prints, rotation print of image, frame printing, etc., from the user in operation 920, and generates a print job file having values indicating the input print settings. The controller 320 stores the generated index file in the folder designated by the user or the optional folder of the storage medium 210 in operation 930.

The controller 320 adds new information, such as storage locations of the generated print job files, to the index file regarding the print jobs in operation 940.

The controller 320 checks if the user has completed inputting print jobs to be printed in operation 950, and, if the user has not completed inputting print jobs, repeats from operations 920 through 940 until the user has completed inputting every print job. In the method of generating and storing the print job files and the index file, a plurality of print job files having print setting values corresponding to image data to be printed are stored in a plurality of optional folders of the storage medium 210, and information on the stored plurality of print job files is stored in a single index file.

FIG. 4 is a view illustrating a directory tree produced when a generated index file is stored in the storage medium 210 of FIG. 2. Referring to FIGS. 2-4, data, such as image data, print job files, an index file, etc., is stored into a predetermined number of folders of the storage medium 210 so that a user can easily identify locations. The file generator 310 generates an index file 400 having information on the print jobs. Then, the controller 410 stores the index file 400 in a folder designated by the user or an optional folder 420 subordinate to a root 410.

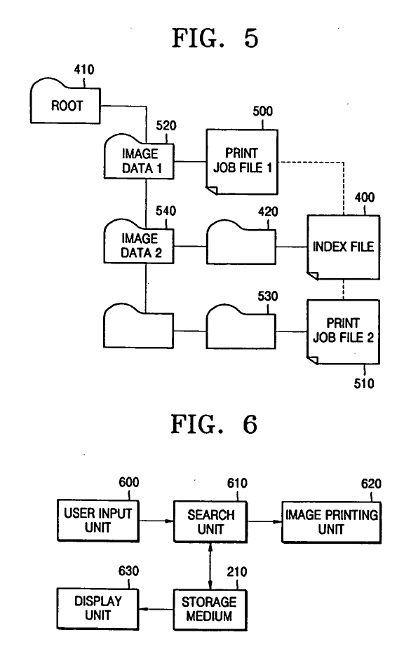

FIG. 5 is a view illustrating a directory tree produced when the generated print job files are stored in the storage medium 210 of FIG. 2. When the user prints image data 1 and 2 stored in folders 520 and 540 of the storage medium 210, respectively, the file generator 310 generates a first print job file 500 and a second print job file 510 corresponding to the image data and, according to the print settings set by the user. The first and second print job files 500 and 510 indicate storage locations of the folders 520 and 540 of the corresponding image data, respectively. The controller 320 stores the generated first and second print job files 500 and 510 in a folder designated by the user or optional folders, for example, the fodders 520 and 530, respectively.

The controller 320 stores information regarding the print job files, e.g., storage locations of the first and second print job files 500 and 510, names of the print jobs, etc., in the index file 400 stored in the folder 420 in the storage medium.

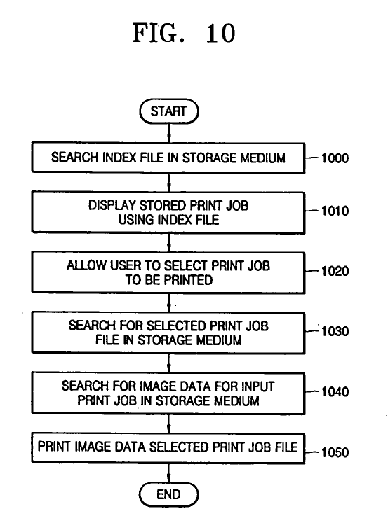

FIG. 6 is a block diagram illustrating an image forming apparatus according to an embodiment of the present general inventive concept. The image forming apparatus comprises a user input unit 600, a search unit 610, an image printing unit 620, and a display unit 630. An operation of the image forming apparatus will now be described with reference to a flow chart illustrating a method of printing image data stored in a storage medium shown in FIG. 10.

Referring to FIGS. 2, 3, 6, and 10, the storage medium 210 in which image data, print job files, and an index file are stored is attached to the image forming apparatus, the user inputs an instruction to perform a print job using the user input unit 600, and the search unit 610 searches for the index file in the storage medium 210 in operation 1000.

The display unit 630 displays information regarding print jobs stored in the storage medium 210 using the searched index file in operation 1010. The user input unit 600 receives an input print job selected from the displayed print jobs by the user in operation 1020. The search unit 610 searches for a print job file of the input print job in the storage medium 210 using storage locations of the print job files indicated in the index file in operation 1030.

The search unit 610 searches for the image data desired by the user in the storage medium 210 using a storage location of the image data stored in the selected print job file in operation 1040. The image print unit 620 prints the selected image data according to print setting values stored in the searched print job file in operation 1050.

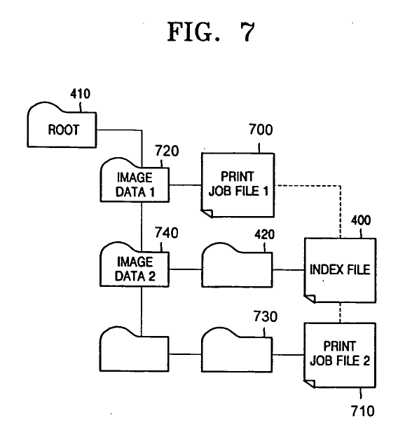

FIG. 7 is a method of searching for print job files and image data in the storage medium of FIG. 6. Referring to FIGS. 5-7, the search unit 610 searches for the index file 400 in the folder 420 in which the index file 400 is stored, and searches for one of the first and second print job files 700 and 710 in the storage locations 720 and 730 according to the print job selected by the user.

The search unit 610 searches for image data desired by the user using the storage locations 720 and 740. The index file and print job files point to storage locations of the print job files and the image data, respectively.

It is possible for the present general inventive concept to be realized on a computer-readable recording medium as a computer-readable code. The computer-readable recording medium may be any kind of recording devices that store computer system-readable data. ROMs, RAMs, CD-ROMs, magnetic tapes, floppy discs, optical data storage, etc., are used as the computer-readable recording medium. The computer-readable recording medium can also be realized in the form of a carrier wave (e.g., transmission through Internet). The computer-readable recording medium is dispersed in a network-connecting computer system, resulting in being stored and executed as the computer-readable code by a dispersion method. A functional program, code and code segments, used to implement the present general inventive concept can be derived by a skilled computer programmer from the description of the invention contained herein.

As described above, in accordance with the image forming system and method using a removable storage medium, images are printed using a plurality of print job files, each corresponding to image data to be printed, and an index file having information on a plurality of print jobs so that user can select a print job stored in a storage medium and easily set print setting values for the image data, thereby reducing time required for a print job and inconvenience caused by a print job.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming system using a removable storage medium and an image forming apparatus, comprising:
an image capturing apparatus to which a storage medium is detachably attached to generate image data, a plurality of print job files corresponding to the respective image data, and an index file having information on the plurality of printing job files, and to store the image data, the print job files, and the index file in the storage medium; and
an image forming apparatus to which the storage medium is detachably attached to receive a selection of one of a plurality of print jobs corresponding to the print job files stored in the storage medium, and to print the image data stored in the storage medium according to one of the print job files corresponding to the selected print job.

2. The system of claim 1, wherein the storage medium has a plurality of folders, and the image capturing apparatus stores the print job files in the plurality of folders of the storage medium.

3. The system of claim 1, wherein the print job files are in an XHTML (extend HTML) format.

4. The system of claim 1, wherein the storage medium comprises a plurality of folders and a plurality of option folders as sub-folders of the plurality of folders, and the storage medium stores the image data in the plurality of folders, and stores the plurality of print job files and the index file in respective ones of the folders and option folders.

5. The system of claim 1, wherein the image forming apparatus comprises:
a display unit to display the print job files stored in the storage medium using the index file;
a user input unit to receive the selection of the print job among the displayed print job files; and
an image print unit to print the image data stored in the storage medium corresponding to the print job file of the selected print job.

6. An image forming method of performing a printing operation using a removable storage medium and an image forming apparatus, the image forming method comprising:
generating image data to be printed, a plurality of print job files corresponding to the respective image data, and an index file having information on the plurality of print job files, and storing the image data, the print job files and the index file in the storage medium;
receiving a selection of one of a plurality of print jobs using the plurality of print job files of the index file; and
printing the image data stored in the storage medium according to one of the print job files corresponding to the selected print job.

7. The method of claim 6, wherein the storage medium has a plurality of folders, and the storing of the plurality of print job files comprises:
storing the print job files in the plurality of folders of the storage medium.

8. The method of claim 6, wherein the storing of the print job files comprises storing the print job files in an XHTML format.

9. The method of claim 6, wherein the receiving of the selection of the one of the plurality of print jobs comprises:
displaying the print jobs stored in the storage medium using the index file; and
receiving the selection of one of the displayed print jobs.

10. The method of claim 6, wherein the printing of the image data comprises:
searching for the print job file of the selected print job in the storage medium;
searching for the image data corresponding to the selected print job in the storage medium; and
printing the searched image data according to print settings stored in the print job file.

11. A computer readable medium having embodied thereon a computer program to perform an image forming method:
generating image data to be printed, a plurality of print job files corresponding to the respective image data, and an index file having information on the plurality of print job files, and storing the image data, the print job files and the index file in the storage medium;
receiving a selection of one of a plurality of print jobs using the plurality of print job files of the index file; and
printing the image data stored in the storage medium according to one of the print job files corresponding to the selected print job.

12. An image capturing apparatus to generate image data and to store the image data in a removable storage medium, comprising:
a data generator to generate the image data;
a file generator to generate a plurality of print job files corresponding to the respective image data for printing, and an index file having information on the print job files; and
a controller to store the image data, print job files, and index file in the storage medium.

13. The apparatus of claim 12, wherein the controller stores the print job files in a plurality of folders of the storage medium.

14. The apparatus of claim 12, wherein the print job files are in an XHTML format.

15. An image forming apparatus to print image data stored in a removable storage medium, comprising:
a user input unit to receive an selection of one of a plurality of print jobs corresponding to a plurality of print job files stored in the storage medium to correspond to respective image data;
a search unit to search for the print job file of the input print job and image data corresponding to the print job file in the storage medium; and
an image printing unit to print the image data corresponding to the selected print job.

16. The apparatus of claim 15, further comprising:
a display unit to display print jobs stored in the storage medium using an index file having information on the print job files stored in the storage medium.

17. The apparatus of claim 15, wherein the search unit searches for the print job file of the input print job in the storage medium using the index file, and searches for the image data corresponding to the selected print job in the storage medium.
